(19) United States
(12) Patent Application Publication
(10) Pub. No.: US 2025/0166152 A1
(43) Pub. Date: May 22, 2025

(54) ELECTRONIC DEVICE, SYSTEM, AND METHOD OF OPERATING THE SAME FOR PROVIDING PAINTING INFORMATION

(71) Applicant: CODEVISION INC., Seoul (KR)

(72) Inventor: Eung Yeol SONG, Seoul (KR)

(73) Assignee: CODEVISION INC., Seoul (KR)

(21) Appl. No.: 19/031,477

(22) Filed: Jan. 18, 2025

Related U.S. Application Data
(63) Continuation of application No. PCT/KR2023/020870, filed on Dec. 18, 2023.

(30) Foreign Application Priority Data
Dec. 19, 2022 (KR) 10-2022-0178125

(51) Int. Cl. G06T 7/00; G05B 11/01; G06T 7/13; G06T 7/64; G06T 7/90

(52) U.S. Cl. CPC G06T 7/0002; G05B 11/01; G06T 7/13; G06T 7/64; G06T 7/90; G06T 2207/10016; G06T 2207/10024; G06T 2207/10028

(57) ABSTRACT

According to various embodiments, the at least one processor may obtain at least one image related to spraying the paint to the target structure through at least one camera, obtain depth information corresponding to the at least one image through the at least one camera and at least one sensor included in the at least one camera, obtain at least one depth image based on the depth information and the at least one image, obtain curvature information identifying the surface curvature of the target structure based on the at least one depth image, obtain paint quality information of the paint for the target structure according to a specified algorithm based on color information of the at least one image and reference color information related to the paint, and display paint information including curvature information and paint quality information.

### CROSS-REFERENCE TO RELATED APPLICATIONS

This application is a Continuation Application of International Application No. PCT/KR2023/020870, filed on Dec. 18, 2023, which is based on and claims priority to Korean Patent Application No. 10-2022-0178125, filed on Dec. 19, 2022, in the Korean Intellectual Property Office, the disclosures of which are incorporated by reference herein in their entireties.

### BACKGROUND

### 1. Field

Various embodiments disclosed in this document relate to a method of obtaining painting information related to spraying painting material to a target structure and an electronic device supporting the same.

### 2. Description of Related Art

The painting of coating paints (e.g., paints) on target structures (e.g., ships, buildings, and facilities) is carried out as an in-door painting and an outdoor painting. The outdoor painting mainly uses a spray type painting for large area painting.

For example, the worker mounts on a high place operation car and sprays the paints on the target structure based on the spray type. The worker manually adjusts the spraying device according to the state in which the paints are applied on the target structure, thereby controlling the spraying speed, spraying pressure, or spraying angle of the paints. In addition, the worker controls the movement of the spraying device for spraying the paints according to the state in which the paints are applied on the target structure. For example, the worker controls the spraying device to move from the area in which the paints are applied to the area in which the paints are not applied.

In this case, in the case of the outdoor painting, scattering paints occur during the process of spraying the paints on the target structure due to the characteristics of the spray type. For example, in the case of painting outdoors, there is a problem in that the painting material is scattered by wind, which is an environmental characteristic. Due to the scattering paints occurring during the painting process, the people living in the vicinity of the target structure have a large damage in property and health, and the safety of the worker who performs the corresponding work is at risk.

### SUMMARY

In order to prevent a significant amount of scattering paints generated during the painting operation on the target structure, it is necessary to develop a painting device including a shielding device. For example, it is necessary to develop a painting device including a shielding device for preventing scattering paints as well as a spraying device.

However, when the painting device including the shielding device is used, it is difficult for the worker who performs the painting operation to check the painting state in which the paints are distributed. For example, the worker is difficult to check whether the paints are properly sprayed due to the shielding device surrounded by the spraying device, whether the paints are applied at the proper quality, and whether there are areas in which the paints are not applied.

The worker needs to record the movement path of the painting device to check whether the paints are applied to all surface areas of the target structure. At this time, when the shielding device is included in the painting device, it is difficult to check the movement path of the painting device.

In addition, when the surface of the target structure has curvature and slope, the worker needs to recognize the curved surface of the target structure to which the paints are to be applied. For example, the worker needs to check the curved surface of the target structure and control the painting device so that the painting device is not separated. However, when the shielding device is included in the painting device, the surface to which the paints are applied is hidden due to the shielding device, and it is difficult for the worker to check whether the paints are curved.

Various embodiments disclosed in this document enable the worker to smoothly perform the painting operation on the target structure by using the painting information obtained through the electronic device even when the paints are distributed on the target structure by using the painting device including the shielding device.

According to various embodiments, the electronic device may include a communication circuit, a display, and at least one processor, wherein the at least one processor may obtain at least one image related to spraying the paint to the target structure through at least one camera connected to the electronic device, wherein the at least one camera is included in the painting device that sprays the paint to the target structure, obtain depth information corresponding to the at least one image through the at least one camera and at least one sensor included in the at least one camera, obtain at least one depth image based on the depth information and the at least one image, obtain curvature information identifying the surface curvature of the target structure based on the at least one depth image, obtain paint quality information of the paint for the target structure according to a specified algorithm based on color information of the at least one image and reference color information related to the paint, and display paint information including curvature information and paint quality information through the display.

According to various embodiments, an operating method of an electronic device connected to the painting device that sprays the paint to the target structure may include obtaining at least one image related to spraying the paint to the target structure through at least one camera included in the painting device, obtaining depth information corresponding to the at least one image through the at least one camera and at least one sensor included in the at least one camera, obtaining at least one depth image based on the depth information and the at least one image, obtaining curvature information identifying the surface curvature of the target structure based on the at least one depth image, obtaining paint quality information of the paint for the target structure according to a specified algorithm based on color information of the at least one image and reference color information related to the paint, and displaying paint information including curvature information and paint quality information through the display included in the electronic device.

According to various embodiments, the electronic device may include a communication circuit, a memory, and at least one processor, wherein the at least one processor may obtain at least one image related to spraying the paint to the target structure through the at least one camera connected to the electronic device, wherein the at least one camera is included in the painting device that sprays the paint to the target structure, obtain depth information corresponding to the at least one image through the at least one camera and at least one sensor included in the at least one camera, obtain at least one depth image based on the depth information and the at least one image, obtain curvature information identifying the surface curvature of the target structure based on the at least one depth image, obtain paint quality information of the paint for the target structure according to a specified algorithm based on color information of the at least one image and reference color information related to the paint, and transmit external electronic devices connected to the electronic device to output paint information including curvature information and paint quality information through the communication circuit.

The electronic device according to various embodiments disclosed in the present disclosure may provide curvature information about the target structure to the user of the electronic device to stably perform the painting operation.

The electronic device according to various embodiments disclosed in the present disclosure may provide the painting quality information about the target structure to the user of the electronic device to perform the painting operation with high quality.

The electronic device according to various embodiments disclosed in the present disclosure may provide the movement path information of the painting device to the target structure to the user of the electronic device to check the path where the paint is applied to the target structure.

The electronic device according to various embodiments disclosed in the present disclosure may control the painting device based on at least one of curvature information, painting quality information, and movement path information about the target structure.

The electronic device according to various embodiments disclosed in the present disclosure may control the painting device so that the spraying device moves according to the target movement path for spraying the paint to the target structure.

According to various embodiments disclosed in this text, the convenience of the painting operation using the painting device including the shielding device may be increased.

In addition, various effects directly or indirectly identified through the present document may be provided.

### BRIEF DESCRIPTION OF THE DRAWINGS

FIG. 1 is a diagram illustrating a painting working system according to various embodiments.

FIG. 2 is a block diagram of an electronic device according to various embodiments.

FIG. 3 is a block diagram illustrating a configuration of devices included in a painting working system according to various embodiments.

FIG. 4 is a flowchart illustrating an operation in which an electronic device obtains curvature information and painting quality information according to various embodiments.

FIG. 5 is a flowchart illustrating an operation in which an electronic device generates curvature information according to various embodiments.

FIG. 6 is a flowchart illustrating an operation in which an electronic device generates painting quality information according to various embodiments.

FIG. 7 is a flowchart illustrating an operation in which an electronic device obtains movement path information according to various embodiments.

FIG. 8 is a flowchart illustrating an operation in which devices included in a painting working system display target painting information according to various embodiments.

FIG. 9 is a flowchart illustrating an operation in which the electronic device, according to various embodiments, transmits a manual control signal to the painting device based on user input.

FIG. 10 is a flowchart illustrating an operation in which an electronic device automatically controls a painting device according to various embodiments.

FIG. 11 is a flowchart illustrating an operation in which an electronic device controls the movement of the paint device according to a target movement path. according to various embodiments

FIG. 12 is a diagram illustrating a user interface of painting information displayed on a display according to various embodiments.

In relation to the description of the drawings, the same or similar reference numerals may be used for the same or similar components.

### DETAILED DESCRIPTION

Specific structural or functional descriptions of various embodiments are merely illustrated for the purpose of describing the various embodiments, and they should not be construed as being limited to the embodiments described in this specification or the application.

Various embodiments can be variously modified and have various forms, and thus various embodiments are illustrated in the drawings and will be described in detail in this specification or the application. However, it should be understood that the matter disclosed from the drawings is not intended to specify or limit various embodiments, but includes all modifications, equivalents, and alternatives included in the spirit and scope of the various embodiments.

The terms first and/or second, etc., may be used to describe various components, but the components should not be limited by the terms. The terms are only for the purpose of distinguishing one component from another component, for example, the first component may be named a second component, and similarly, the second component may be named a first component, without deviating from the scope of rights according to the concept of the present disclosure.

When an element is referred to as being “connected” or “connected” to another component, it should be understood that the element may be directly connected or connected to the other component, but other components may be present in the middle. On the other hand, when an element is referred to as being “directly connected” or “directly connected” to another component, it should be understood that there is no intervening component. Other expressions that describe the relationship between components, that is, “between” and “immediately between” or “adjacent to” and “directly adjacent to” should be interpreted as well.

The terminology used in this specification is used merely to describe a specific embodiment, and is not intended to limit various embodiments. The singular expression includes plural expressions unless the context clearly dictates otherwise. In this specification, it should be understood that the terms “include” or “have” are intended to designate the presence of stated features, numbers, steps, operations, components, parts or combinations thereof, but do not preclude the presence or addition of one or more other features, numbers, steps, operations, components, parts or combinations thereof.

Unless defined otherwise, all terms used herein, including technical or scientific terms, are the same meaning as commonly understood by one of ordinary skill in the art to which this disclosure belongs. Terms such as those defined in commonly used dictionaries should be interpreted to have a meaning that is consistent with the contextual meaning in the relevant art, and is not interpreted in an idealready or overly formal sense unless clearly defined in this specification.

Hereinafter, the present disclosure will be described in detail with reference to the preferred embodiments of the present disclosure with reference to the accompanying drawings. The same reference numerals provided in each drawing indicate the same members.

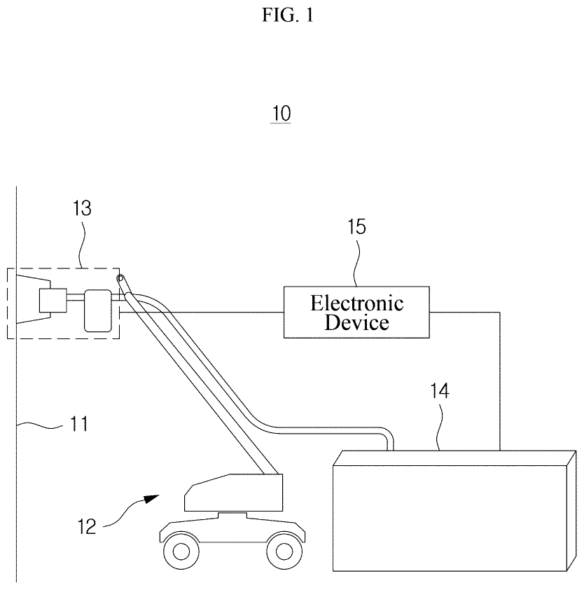

FIG. 1 is a diagram illustrating a painting work system 10 according to an embodiment.

Referring to FIG. 1, the painting work system 10 may include a target structure 11, a painting device 310 for spraying paints to the target structure 11, a high place operation car 12 connected to the painting device 13, a trailer 14 connected to the painting device 13 and including various components related to the use of the painting device 13, and an electronic device 15.

According to various embodiments, the target structure 11 may be a target for spraying paints. For example, the target structure 11 may include a structure that needs to spray paints to a region having a specific size or larger than a specific size, such as a ship, a building, and a facility.

According to various embodiments, the high place operation car 12 may include various structures and functions that allow the painting device 13 to be located close to the target structure 11 so that the painting device 13 may properly spray paints to the target structure 11. According to various embodiments, in the outdoor painting work that performs the painting work on the target structure 11 outdoors, the high place operation car 12 may be used to work. In various embodiments, a basket portion, which is an upper end portion of the high place operation car 12, may be connected to the painting device 13. According to various embodiments, the worker who performs the painting work on the target structure 11 may board the basket portion of the high place operation car 12 to perform the painting work on the target structure 11.

Hereinafter, the worker who performs the painting work on the target structure 11 may be expressed as the user of the electronic device 15.

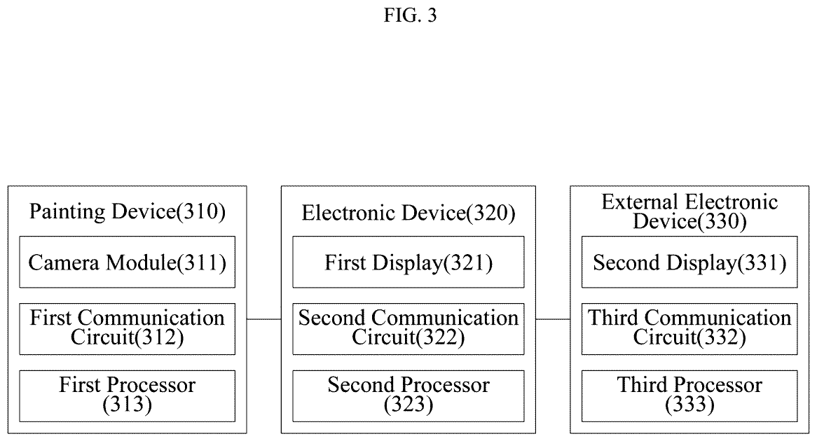

According to various embodiments, the painting device 13 may include a spray device (not shown) that controls the paint to be sprayed, a shielding device (not shown) that prevents scattering paints from spreading to the outside, and a suction device (not shown) that suctions scattering paints. A camera module (e.g., the camera module 311 of FIG. 3) including at least one camera that obtains an image related to the spray state of the paint and at least one sensor included in the at least one camera may be included.

According to various embodiments, the painting device 13 may prevent scattering paints from leaking to the outside through the shielding device and collect scattering paints through the suction device.

According to various embodiments, the painting device 13 may include a spray device and a filter. In an embodiment, the spray device may include a nozzle (spray gun) for spraying paints. In an embodiment, the spray pressure of the spray device may be variously adjusted. For example, the spray pressure of the spray device may be adjusted from 10 bar to 200 bar according to the painting type and the work environment (temperature and humidity).

According to various embodiments, the worker may perform the painting work on the target structure 11 using the painting device 13. For example, the worker may control at least one of the spray pressure, speed, angle, time, spray amount, or the size of the nozzle of the painting device 13 to perform the painting the painting work on the target structure 11.

According to various embodiments, at least one of the injection pressure, speed, angle, time, amount of injection, or the size of the nozzle of the spraying device 13 may be controlled based on the control signal obtained from the electronic device 15. In addition, the movement of the painting device 13 with respect to the target structure 11 may be controlled based on the control signal obtained from the electronic device 15.

According to various embodiments, a description of a configuration included in the painting device 13 will be described below with reference to FIG. 3.

According to various embodiments, the trailer 14 may include a controller of high place operation car 12, a paint pump, a dust collector, a vacuum/air supply, and/or an electrical controller. According to various embodiments, the trailer 14 is not limited to the described components, and may include various facilities necessary to perform the painting operation on the target structure 11.

According to various embodiments, the electronic device 15 may provide various functions related to the painting operation on the target structure 11. According to various embodiments, the electronic device 15 may provide information on the painting operation on the target structure 11. According to various embodiments, the electronic device 15 may control the painting device 13 and/or various facilities included in the trailer 14 so that the painting operation on the target structure 11 may be performed.

For example, the electronic device 15 may provide various information related to the painting operation on the target structure 11 to a user who is the worker of the painting operation. For example, the electronic device 15 may provide the user with surface curvature information of the target structure 11 and/or painting quality information of the target structure 11. For example, the electronic device 15 may provide the user with information on the path where the paint is sprayed through the painting device 13, that is, the movement path of the painting device 13.

According to various embodiments, the electronic device 15 may transmit various information related to the painting operation to the user by an external electronic device (e.g., the external electronic device 330 of FIG. 3). The operations of the electronic device 15 and the external electronic device according to various embodiments will be described below with reference to the drawings.

According to various embodiments, the user may obtain information on the painting operation on the target structure 11 and control the painting operation despite the shielding device being included in the painting device 13 through the electronic device 15.

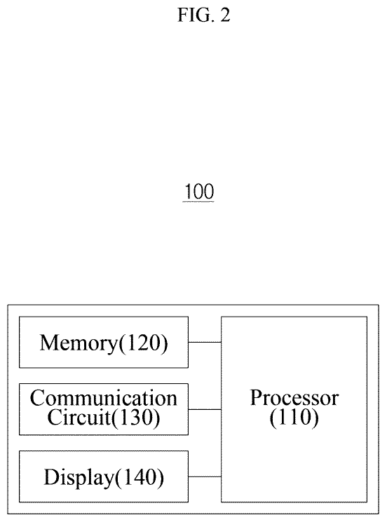

FIG. 2 is a block diagram of an electronic device 100 according to an embodiment.

Referring to FIG. 2, the electronic device 100 may include a processor 110, a memory 120, a communication circuit 130, and/or a display 140. The above-listed components may be operatively or electrically connected to each other. For example, some of the components of the electronic device 100 illustrated in FIG. 2 may be modified, deleted, or added.

According to various embodiments, the electronic device 100 may include a processor s 110. In various embodiments, the processor 110 may control at least one other component (e.g., a hardware or software component) of the electronic device 100 connected to the processor 110 by executing software (e.g., a program), and may perform various data processing or computation. According to various embodiments, as at least a part of the data processing or calculation, the processor 110 may store the command or data received from another component (e.g., the communication circuit 130) in a volatile memory, process the command or data stored in the volatile memory, and store the resultant data in a non-volatile memory. According to various embodiments, the processor 110 may include a main processor (e.g., a central processing unit) or an auxiliary processor (e.g., a graphic processing unit, a neural network processing unit (NPU), an image signal processor, a sensor hub processor, or a communication processor) that is operable independently of or in conjunction with the main processor (e.g., a central processing unit). For example, when the electronic device 100 includes a main processor and an auxiliary processor, the auxiliary processor may be configured to use lower power than the main processor or to be specific to a specified function. The auxiliary processor may be implemented separately from the main processor or as a part thereof.

The auxiliary processor may control at least a part of a function or state related to at least one component (e.g., the display 140 or the communication circuit 130) of the components of the electronic device 100, for example, instead of the main processor while the main processor is in an inactive (e.g., sleep) state, or together with the main processor while the main processor is in an active (e.g., application execution) state. According to various embodiments, the auxiliary processor (e.g., the communication processor) may be implemented as a part of another component (e.g., the communication circuit 130) functionally related to the auxiliary processor. According to various embodiments, the auxiliary processor (e.g., the neural network processing unit) may include a hardware structure specific to the processing of the artificial intelligence model. The artificial intelligence model may be generated through machine learning. Such learning may be performed, for example, in the electronic device 100 itself in which the artificial intelligence is performed, or may be performed through a separate server. The learning algorithm may include, for example, supervised learning, unsupervised learning, semi-supervised learning, or reinforcement learning, but is not limited to the above examples. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the above, but is not limited to the above examples. The artificial intelligence model may additionally or alternatively include a software structure in addition to the hardware structure.

According to various embodiments, the processor 110 may execute calculations or data processing related to the control and/or communication of at least one other components of the electronic device 100 by using instructions stored in the memory 120. According to an embodiment, the processor 110 may include at least one of a central processing unit (CPU), a graphic processing unit (GPU), a micro controller unit (MCU), a), a sensor hub, an supplementary processor, a communication processor, an application processor, an application specific integrated circuit (ASIC), a field programmable gate arrays (FPGA), or a neural processing unit (NPU).

According to various embodiments, the processor 110 may obtain at least one image related to spraying the paint to the target structure (e.g., the target structure 11 of FIG. 1). For example, the processor 110 may obtain at least one image related to spraying the paint from at least one camera included in the painting device that sprays the paint to the target structure. In addition, the processor 110 may obtain a video for spraying the paint to the target structure from the at least one camera. For example, the processor 110 may obtain the at least one image and/or the video from the painting device through the communication circuit 130.

According to various embodiments, the processor 110 may obtain depth information corresponding to the at least one image. For example, the processor 110 may obtain the depth information from the painting device through the communication circuit 130. According to various embodiments, the depth information may include depth map data obtained through at least one sensor included in the painting device.

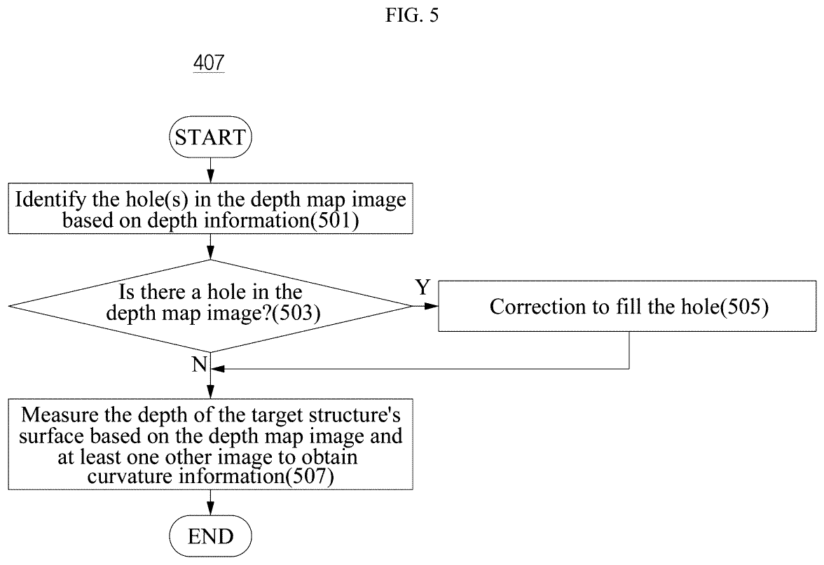

According to various embodiments, the processor 110 may obtain at least one depth image based on the depth information and the at least one image. According to various embodiments, the operation of the processor 110 to obtain the at least one depth image will be described below with reference to FIG. 5.

According to various embodiments, the processor 110 may obtain curvature information identifying the surface curvature of the target structure based on the at least one depth image. For example, the processor 110 may obtain curvature information of the surface of the target structure corresponding to the location of the painting device. According to various embodiments, the curvature information may include information on the depth of the surface of the target structure, and thus may be information necessary to properly spray the paint to the target structure.

According to various embodiments, the processor 110 may obtain color information (e.g., RGB value) of the at least one image and reference color information (e.g., RGB value) of the paint sprayed to the target structure. According to various embodiments, the processor 110 may obtain paint quality information of the target structure according to a specified algorithm (e.g., watershed) based on the color information of the at least one image and the reference color information of the paint. For example, when the paint is sprayed to the target structure through the painting device, the processor 110 may obtain paint quality information indicating whether the paint is properly sprayed to the surface of the target structure. According to various embodiments, the user of the electronic device 100 may check whether the paint is properly sprayed to the target structure based on the paint quality information.

According to various embodiments, the electronic device 100 may include the memory 120. According to various embodiments, the memory 120 may store various data used by at least one component (e.g., the processor 110) of the electronic device 100. The data may include, for example, software (e.g., a program) and input data or output data related to a command. The memory 120 may include volatile memory or non-volatile memory.

According to various embodiments, the program may be stored in the memory 120 as software, and may include, for example, an operating system, middleware, or an application. According to various embodiments, the memory 120 may store instructions that allow the processor 110 to process data or control components of the electronic device 100 to perform the operations of the electronic device 100 when executed. The instructions may include code generated by a compiler or code that may be executed by an interpreter.

According to various embodiments, the memory 120 may store various information obtained through the processor 110. For example, the memory 120 may store at least one of curvature information indicating a surface of the target structure obtained from the processor 110, painting quality information indicating a painting state, movement path information of the painting device for the target structure, painting quality information for each position of the painting device, curvature information for each position of the painting device, or real-time video in which the paint is sprayed. In addition, the memory 120 may store identification information for the painting device or the external electronic device (e.g., the external electronic device 330 of FIG. 3) connected to the electronic device 100.

According to various embodiments, the memory 120 may store at least one application that can perform various functions. For example, the memory 120 may store an application that provides a function related to the painting operation for the target structure. For example, the memory 120 may store an application that provides at least one of curvature information indicating a surface of the target structure, painting quality information indicating a painting state, movement path information of the painting device for the target structure, painting quality information for each location of the painting device, curvature information for each location of the painting device, or real-time video in which the paint is sprayed. For example, the memory 120 may store an application that obtains an input from a user or obtains an input from the processor 110 to control the operation of the painting device.

According to various embodiments, the electronic device 100 may include a communication circuit 130. In various embodiments, the communication circuit 130 may support the establishment of a direct (e.g., wired) communication channel or a wireless communication channel between the electronic device 100 and the external electronic device (e.g., the painting device 310 of FIG. 3, the external electronic device 330 of FIG. 3, or a server (not shown)), and communication performance through the established communication channel. The communication circuit 130 may include one or more communication processors that operate independently of the processor 110 and support direct (e.g., wired) communication or wireless communication. According to an embodiment, the communication circuit 130 may include a wireless communication module (e.g., a cellular communication module, a short-range wireless communication module, or a global navigation satellite system (GNSS) communication module), or a wired communication module (e.g., a local area network (LAN) communication module, or a power line communication module). A corresponding communication module among these communication modules may communicate with external electronic devices through a first network (e.g., a short-range communication network s such as Bluetooth, WiFi direct, or infrared data association association (IrDA)), or a second network (e.g., legacy cellular network, 5G network, next generation communication network, or Internet, or a long-range communication network s such as a computer network (e.g., LAN or WAN)). These various types of communication modules may be integrated into one component (e.g., a single chip), or may be implemented as a plurality of separate components (e.g., a plurality of chips).

According to various embodiments, the electronic device 100 may be connected to the painting device and/or the external electronic device through the communication circuit 130. According to various embodiments, the electronic device 100 may transmit and receive various data to and from the painting device and/or the external electronic device through the communication circuit 130. For example, the electronic device 100 may obtain at least one image related to spraying the paint from the painting device to the target structure, depth information corresponding to the at least one image and/or coordinate information related to movement of the painting device, and a video related to spraying the paint through the communication circuit 130. For example, the electronic device 100 may transmit curvature information indicating the surface of the target structure, paint quality information indicating the painting state, movement path information of the painting device with respect to the target structure, paint quality information for each position of the painting device, curvature information for each position of the painting device, or real-time video in which the paint is sprayed to the external electronic device via the communication circuit 130.

According to various embodiments, the electronic device 100 may include the display 140. The display 140 may visually provide information to the outside (e.g., the user) of the electronic device 100. According to various embodiments, the display 140 may display various content (e.g., text, image, video, icon, and/or symbol). According to various embodiments, the display 140 may include a liquid crystal display (LCD), a light-emitting diode (LED) display, or an organic light-emitting diode (OLD) display.

According to various embodiments, the display 140 may display various information obtained from the processor 110. For example, the display 140 may display at least one of curvature information indicating the surface of the target structure, paint quality information indicating the painting state, movement path information of the painting device with respect to the target structure, paint quality information for each position of the painting device, curvature information for each position of the painting device, or real-time video in which the paint is sprayed.

According to various embodiments, the electronic device 100 may provide various notifications through the display 140. For example, in relation to spraying the paint to the target structure, various notifications such as warning notifications, automatic control notifications, and manual control notifications may be provided.

According to various embodiments, the electronic device 100 may include a hologram device for operation of the display 140, or a projector, and a control circuit for controlling the corresponding device. According to an embodiment, the display 140 may include a touch sensor set to sense a touch, or a pressure sensor set to measure the intensity of force generated by the touch.

According to various embodiments, the electronic device 100 may obtain user input from the user through the touch sensor of the display 140. For example, the electronic device 100 may obtain input for controlling the painting device from the user through the display 140.

According to various embodiments, the electronic device 100 may include various components in addition to the components shown in FIG. 2.

According to various embodiments, the electronic device 100 may include an input module (not shown). The input module may receive a command or data to be used in a component (e.g., the processor 110) of the electronic device 100 from the outside (e.g., the user) of the electronic device 100. The input module may include, for example, a microphone, a mouse, a keyboard, a key (e.g., a button), or a digital pen (e.g., a stylus pen).

According to various embodiments, the electronic device 100 may obtain a user input for controlling the painting device from the user through the input module. The electronic device may transmit a control signal for controlling the painting device to the painting device based on the user input obtained through the input module.

According to various embodiments, the electronic device 100 may include an interface (not shown). In an embodiment, the interface may support one or more designated protocols that may be used by the electronic device to be directly or wirelessly connected to an external electronic device (e.g., the painting device 310 of FIG. 3, and the external electronic device 330 of FIG. 3). According to an embodiment, the interface may include, for example, a high definition multimedia interface (HDMI), a universal serial bus (USB) interface, an SD card interface, or an audio interface.

According to various embodiments, the electronic device 100 may include a connection terminal (not shown). The connection terminal may include a connector through which the electronic device 100 may be physically connected to an external electronic device (e.g., the painting device 310 of FIG. 3, and the external electronic device 330 of FIG. 3).

FIG. 3 is a block diagram illustrating a configuration of devices included in a painting working system according to various embodiments.

According to various embodiments, the painting working system (e.g., the painting working system 10 of FIG. 1) may include the painting device 310 (e.g., the painting device 13 of FIG. 1), the electronic device 320 (e.g., the electronic device 15 of FIG. 1, and the electronic device 100 of FIG. 2), and/or the external electronic device 330.

According to various embodiments, the painting device 310 may include the camera module 311, the first communication circuit 312, and/or the first processor 313. According to various embodiments, the electronic device 320 may include the first display 321 (e.g., the display 140 of FIG. 2), the second communication circuit 322 (e.g., the communication circuit 130 of FIG. 2), and/or the second processor 323 (e.g., the processor 110 of FIG. 2). According to various embodiments, the external electronic device 330 may include the second display 331, the third communication circuit 332, and/or the third processor 333. According to various embodiments, the components listed in the painting device 310, the electronic device 320, and/or the external electronic device 330 may be partially modified, deleted, or added.

According to various embodiments, the first communication circuit 312, the second communication circuit 322, and/or the third communication circuit 332 may perform a function similar to the communication circuit 130 described with reference to FIG. 2. According to various embodiments, the first display 321 and/or the second display 331 may perform a function similar to the display 140 described with reference to FIG. 2. Therefore, redundant or similar description with FIG. 1 or 2 may be omitted below.

According to various embodiments, the first processor 313 of the painting device 310 may obtain at least one image related to spray painting paintaste to the target structure (e.g., the target structure 11).

According to various embodiments, the camera module 311 of the painting device 310 may include a first camera that photographs an area before the paint is being sprayed, a second camera that photographs a state in which the paint is being sprayed, and/or a second camera that photographs an area after the paint is being sprayed, in association with the spraying device (e.g., the spraying device described with reference to FIG. 1). According to various embodiments, the painting device 310 may obtain, through the camera module 311, at least one image including an image of an area before the paint is being sprayed, an image indicating a state in which the paint is being sprayed, and an image of an area after the paint is being sprayed. According to various embodiments, the first processor 313 may transmit the at least one image to the electronic device 320 through the first communication circuit 312.

According to various embodiments, the camera module 311 of the painting device 310 may include at least one sensor. For example, the camera module 311 may include a depth sensor (e.g., an infrared sensor) that can measure the depth of the object. For example, the camera module 311 may include an infrared sensor that emits infrared light and measures the depth through an infrared source value reflected by the object. For example, the camera module 311 may include a position sensor (e.g., an IMU sensor), a gyro sensor, or an acceleration sensor that can sense movement and movement of the painting device 310.

According to various embodiments, the painting device 310 may transmit, to the electronic device 320 through the first communication circuit 312, information obtained through the at least one sensor. For example, the painting device 310 may transmit, to the electronic device 320 through the first communication circuit 312, depth information on the target structure obtained by measuring the depth and/or coordinate information of the painting device 310 obtained through the position sensor. According to various embodiments, the operation of the painting device 310 may be performed through the first processor 313.

According to various embodiments, the electronic device 320 may generate a depth image based on the at least one image and the depth information obtained from the painting device 310 through the second communication circuit 322. In addition, the electronic device 320 may obtain curvature information identifying the surface curvature of the target structure based on the depth image.

According to various embodiments, the electronic device 320 may obtain painting quality information based on color information of the at least one image obtained through the second communication circuit 322 and reference color information of the paint.

According to various embodiments, the electronic device 320 may obtain movement path information of the painting device 310 based on coordinate information of the painting device 310 obtained from the painting device 310 through the second communication circuit 322.

According to various embodiments, the electronic device 320 may display curvature information, painting quality information, and/or movement path information through the first display 321.

According to various embodiments, the electronic device 320 may generate a control signal based on the curvature information, painting quality information, and/or movement path information. In addition, the electronic device 320 may control the painting device 310 based on the control signal. In addition, the electronic device 320 may control the painting device 310 based on the input from the user. According to various embodiments, the operation of the electronic device 320 may be performed through the second processor 323.

According to various embodiments, the electronic device 320 may transfer the curvature information, the painting quality information, and/or the movement path information to the external electronic device 330 through the second communication circuit 322.

The operation of the electronic device 320 according to various embodiments will be described below with reference to the drawings.

According to various embodiments, the external electronic device 330 may obtain various information related to spraying the painting material to the target structure from the electronic device 320. For example, the external electronic device 330 may obtain at least one of curvature information indicating the surface of the target structure, painting quality information indicating the painting state, movement path information of the painting device with respect to the target structure, painting quality information for each position of the painting device, curvature information for each position of the painting device, or real-time video in which the painting material is sprayed through the third communication circuit 332.

According to various embodiments, the external electronic device 330 may display at least one of curvature information indicating the surface of the target structure, painting quality information indicating the painting state, movement path information of the painting device with respect to the target structure, painting quality information for each position of the painting device, curvature information for each position of the painting device, or real-time video in which the painting material is sprayed through the second display 331.

The electronic device (e.g., the electronic device 320 of FIG. 3, the external electronic device 330) according to various embodiments may be various types of devices. The electronic device (e.g., the electronic device 320 of FIG. 3) may include, for example, a portable communication device (e.g., a smartphone), a computer device, a portable multimedia device, a portable medical device, a camera, a wearable device, or a home appliance. The electronic device according to an embodiment of the present document is not limited to the above-described devices.

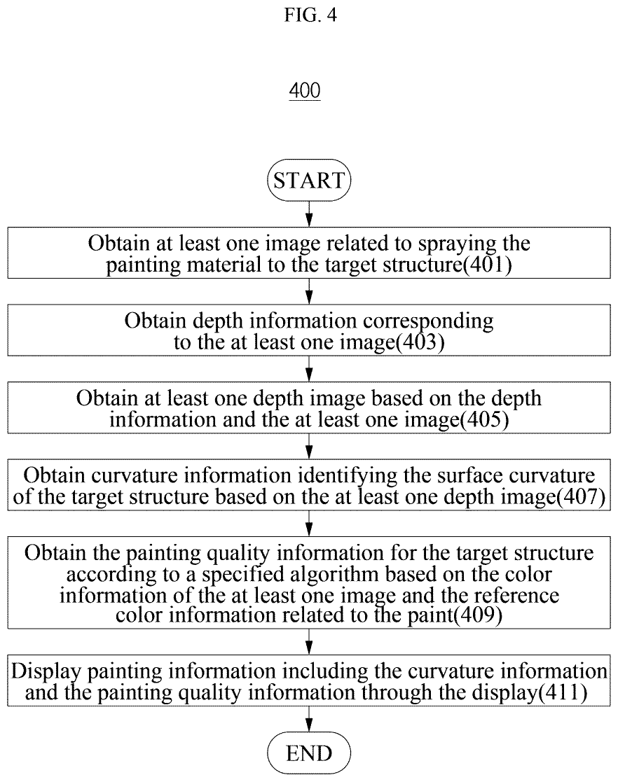

FIG. 4 is a flowchart 400 illustrating an operation in which the electronic device according to an embodiment obtains curvature information and painting quality information.

Each of the operations described below may be performed in combination with each other. In addition, the operations described below by the electronic device 100 (e.g., the electronic device 15 of FIG. 1, and the electronic device 320 of FIG. 3) may mean the operations by the processor 110 (e.g., the second processor 323 of FIG. 3) of the electronic device 100.

In addition, “information” described below may be interpreted as meaning “data” or “signal”, and “data” may be understood as concepts including both analog data and digital data.

According to various embodiments, the operations illustrated in FIG. 4 are not limited to the order illustrated, but may be performed in various orders. In addition, according to various embodiments, more operations may be performed or at least one operation may be less than the operations illustrated in FIG. 4.

Referring to FIG. 4, the electronic device 100 (e.g., the electronic device 15 of FIG. 3, and the electronic device 320) may obtain at least one image related to spraying the painting material to the target structure 11 described with reference to FIG. 1. For example, the electronic device 100 may obtain at least one image obtained through at least one camera included in the painting device 310 (e.g., the painting device 13 of FIG. 1) described with reference to FIG. 3 that sprays paint to the target structure 11.

According to various embodiments, in operation 403, the electronic device 100 may obtain depth information corresponding to the at least one image. For example, the electronic device 100 may obtain depth information corresponding to at least one image obtained through the at least one camera and the at least one sensor described with reference to FIG. 3.

According to various embodiments, in operation 405, the electronic device 100 may obtain at least one depth image based on the depth information and the at least one image. For example, the electronic device 100 may process the at least one image and depth information to obtain at least one depth image displayed so that the depth appears. For example, the electronic device 100 may obtain at least one depth image indicating the depth of the surface of the target structure according to the pixel.

According to various embodiments, in operation 407, the electronic device 100 may obtain curvature information identifying the surface curvature of the target structure based on the at least one depth image. The content of obtaining the curvature information according to various embodiments will be described below with reference to FIG. 5.

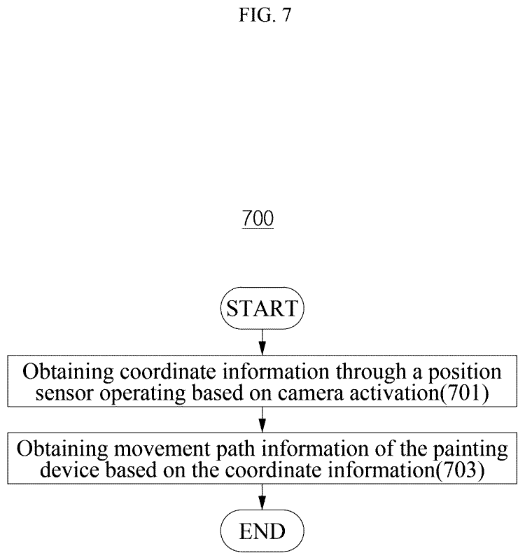

According to various embodiments, in operation 409, the electronic device 100 may obtain the painting quality information of the painting device 310 for the target structure 11 according to a specified algorithm (e.g., watershed) based on the color information of the at least one image and the reference color information related to the paint. The content of obtaining the curvature information according to various embodiments will be described below with reference to FIG. 7.

According to various embodiments, in operation 411, the electronic device 100 may display painting information including the curvature information and the painting quality information through the display 140 (e.g., the first display 321 of FIG. 3).

According to various embodiments, the electronic device 100 may transmit painting information including the curvature information and the painting quality information so that the external electronic device 330 described with reference to FIG. 3 outputs the curvature information and the painting quality information.

FIG. 5 is a flowchart 407 illustrating an operation in which the electronic device according to an embodiment generates the curvature information.

According to various embodiments, operations illustrated in FIG. 5 are not limited to the order illustrated, but may be performed in various orders. In addition, according to various embodiments, more operations may be performed or fewer operations may be performed than the operations illustrated in FIG. 5.

Referring to FIG. 5, in operation 407, the electronic device 100 may generate the curvature information through operations 501 to 507 described with reference to FIG. 4. The same or similar descriptions as described with reference to FIG. 4 may be omitted below.

According to various embodiments, in operation 501, the electronic device 100 may identify the hole of the depth map image based on the depth information in the basis in operation 501. For example, the electronic device 100 may obtain a depth map image based on the depth information. In addition, the electronic device 100 may identify a hole in the depth map image. For example, the electronic device 100 may identify a hole generated in the depth map image when there is no infrared source value reflected by the target structure 11.

According to various embodiments, the electronic device 100 may determine whether there is a hole in the depth map image in operation 503.

According to various embodiments, when there is a hole in the depth map image (503—YES), the electronic device 100 may perform correction to fill the hole in operation 505. For example, the electronic device 100 may fill the hole region with the same pixel as the pixel of the neighboring area (neighboring pixels) of the hole region in the depth map image. Therefore, the electronic device 100 may obtain the corrected depth map image in which the hole is filled.

According to various embodiments, the electronic device 100 may obtain curvature information by measuring the depth of the surface of the target structure 11 based on the depth map image and the at least one image in operation 507. For example, the electronic device 100 may obtain the surface curvature information of the target structure 11 of the area where the painting device 310 is to spray the paint.

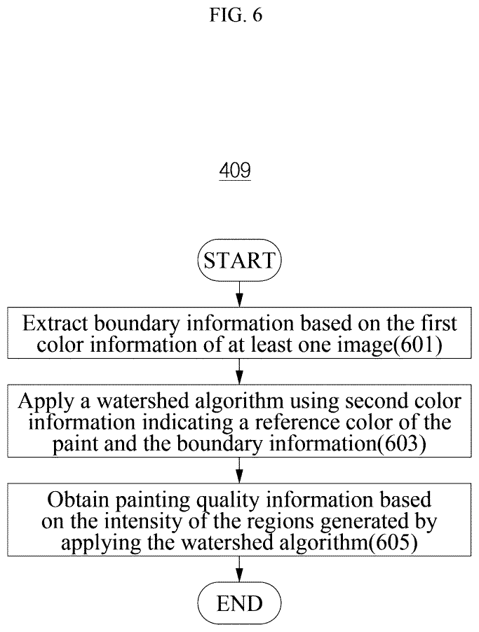

FIG. 6 is a flowchart illustrating an operation in which an electronic device generates painting quality information according to various embodiments.

According to various embodiments, the operations illustrated in FIG. 6 are not limited to the order illustrated, but may be performed in various orders. In addition, according to various embodiments, more operations may be performed or fewer operations may be performed than the operations illustrated in FIG. 6.

Referring to FIG. 6, the electronic device 100 may generate painting quality information through operations 601 to 605 in operation 409 described with reference to FIG. 4. The same or similar descriptions as those described with reference to FIG. 4 may be omitted below.

According to various embodiments, the electronic device 100 may extract boundary information based on first color information (e.g., RGB) of the at least one image described with reference to FIG. 4 in operation 601. For example, the electronic device 100 may extract boundary information for the at least one image using a designated algorithm.

According to various embodiments, the electronic device 100 may apply a watershed algorithm using second color information (RGB) indicating a reference color of the paint and the boundary information in operation 603. For example, the electronic device 100 may obtain a mask result value by applying the watershed algorithm to the second color information and the boundary information. According to various embodiments, the paint may indicate the paint sprayed to the target structure 11 through the painting device 310. According to various embodiments, when the color of the paint applied to each surface area of the target structure 11 is different, the watershed algorithm may be applied based on various reference color information.

According to various embodiments, in operation 605, the electronic device 100 may obtain intensity information about areas generated according to the application of the watershed algorithm.

According to various embodiments, the electronic device 100 may obtain painting quality information based on the intensity information. For example, the electronic device 100 may identify an area of the first color information compared to the second color information, and identify the quality of the painting according to the depth of the generated valley by applying the watershed algorithm.

According to various embodiments, the painting quality information may include information about various painting defects occurring during the painting operation on the target structure 11. For example, the painting quality information may include at least one of pinhole, sagging, bubble, wrinkling, lifting, orange peel, fish eye, cratering, peeling, cracking, and blistering.

FIG. 7 is a flowchart 700 illustrating an operation in which an electronic device obtains movement path information, according to an embodiment.

According to various embodiments, the operations illustrated in FIG. 7 may be performed in various orders without being limited to the order illustrated. In addition, according to various embodiments, more operations may be performed or fewer operations may be performed than the operations illustrated in FIG. 7.

Referring to FIG. 7, the electronic device 100 (e.g., the electronic device 15 of FIG. 1, in operation 701 and the electronic device 320 of FIG. 3) may obtain coordinate information through a position sensor operating based on camera activation. According to various embodiments, at least one sensor included in the painting device 310 (e.g., the painting device 13 of FIG. 1) described with reference to FIG. 3 may include a position sensor. According to various embodiments, the electronic device 100 may obtain coordinate information from the position sensor operating as the at least one camera of the painting device 310 described with reference to FIG. 3 is activated through the communication circuit 130 (e.g., the second communication circuit 322 of FIG. 3).

According to various embodiments, the electronic device 100 may obtain relative coordinate information obtained through the position sensor operating as the at least one camera is activated from the painting device 310 (e.g., the IMU sensor). For example, the painting device 310 may record the relative coordinate according to the movement of the painting device 310 starting with (0,0,0) as the at least one camera is activated, and transmit the generated relative coordinate information to the electronic device 100.

According to various embodiments, in operation 703, the electronic device 100 may obtain movement path information of the painting device 310 based on the coordinate information. The electronic device 100 may record relative coordinates corresponding to the location where the painting device 310 moves, and obtain movement path information of the painting device 310 based on the recorded relative coordinates.

According to various embodiments, the electronic device 100 may display movement path information through the display 140 (e.g., the first display 321 of FIG. 3). In addition, the electronic device 100 may transmit the external electronic device 330 described with reference to FIG. 3 to output the movement path information. The external electronic device 330 may display the movement path information through the second display 331 described with reference to FIG. 3.

According to various embodiments, the electronic device 100 may obtain the painting quality information for each position and the curvature information for each position corresponding to each of the locations where the painting device 310 moved based on the movement path information. For example, the electronic device 100 may obtain the painting quality information and the curvature information obtained from each of the coordinates indicating the location where the painting device 310 moved based on the movement path information.

According to various embodiments, the electronic device 100 may combine the movement path information with at least one of the painting quality information for each position or the curvature information for each position to display the painting information for each position through the display 140. The electronic device 100 may transmit the external electronic device 330 to output the painting information for each position. The external electronic device 330 may display the painting information for each position through the second display 331.

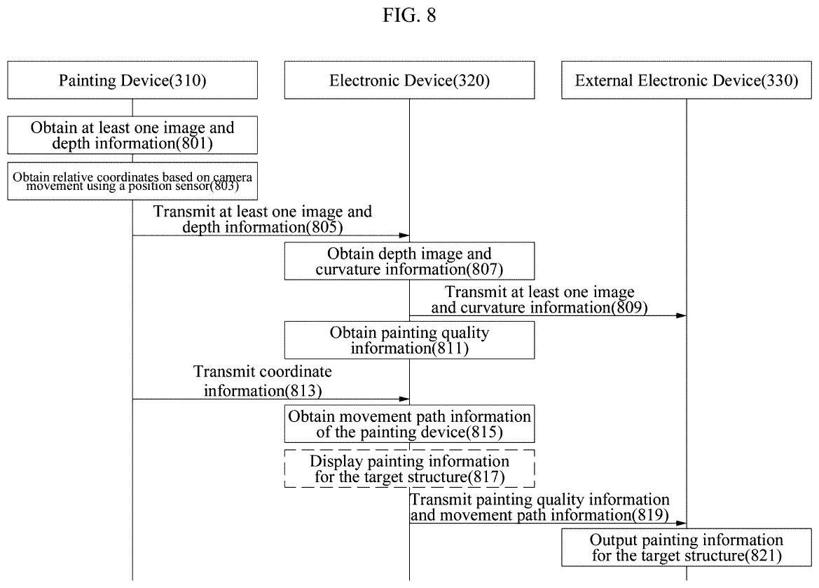

FIG. 8 is a flowchart 800 illustrating an operation of displaying target painting information by devices included in a painting task system, according to an embodiment.

According to various embodiments, the operations illustrated in FIG. 8 are not limited to the order illustrated, but may be performed in various orders. In addition, according to various embodiments, more operations may be performed or fewer operations may be performed than the operations illustrated in FIG. 8.

Referring to FIG. 8, operations of the painting device 310 (e.g., the painting device 13 of FIG. 1), the electronic device 320 (e.g., the electronic device 15 of FIG. 1, the electronic device 100 of FIG. 2), and the external electronic device 330 are illustrated. Hereinafter, the operations of the painting device 310, the electronic device 320, and the external electronic device 330 may mean be performed by the first processor 313, the second processor 323, and the third processor 333, respectively.

According to various embodiments, the painting device 310 may obtain at least one image and depth information 801.

According to various embodiments, the painting device 310 may obtain the depth information indicating the depth of the surface of the target structure (e.g., the target structure 11 of FIG. 1) through at least one sensor (e.g., the depth sensor, the infrared sensor) included in the camera module (e.g., the camera module 311 of FIG. 3). According to various embodiments, the camera including the depth sensor may be represented by a depth camera. The depth camera may be configured to obtain an image having depth information, such as a depth image including depth map data.

According to various embodiments, the depth image for the surface of the target structure may include a pixel area of the captured scene, and each pixel may indicate a depth value s such as a length or a distance for the surface of the target structure in the scene obtained from the depth camera through centimeters, millimeters, or various references.

For example, at least one sensor may obtain the depth information based on infrared infrared rays reflected by the surface of the target structure 11. According to various embodiments, the depth information may correspond to at least one image.

According to various embodiments, the painting device 310 may obtain relative coordinates according to the movement of the at least one camera described with reference to FIG. 3 through the position sensor described with reference to FIG. 3 803. For example, the painting device 310 may obtain, as the relative coordinates, x=0, y=0, and z=0 when the at least one camera is activated through the position sensor (e.g., the IMU sensor), and the position relatively moved as the at least one camera moves as the painting device 310 is moved.

According to various embodiments, the painting device 310 may transmit at least one image and depth information to the electronic device 320 805. For example, as the first communication circuit 312 of the painting device 310 is connected to the second communication circuit 322 of the electronic device 320, the painting device 310 may transmit at least one image and depth information to the electronic device 320.

According to various embodiments, the electronic device 320 may obtain 807 the depth image and curvature information based on the at least one image and depth information 807. For example, the electronic device 320 may generate and obtain curvature information by performing the operation described with reference to FIGS. 4 and 5.

According to various embodiments, the electronic device 320 may transmit 809 the at least one image and curvature information to the external electronic device 330 809. For example, as the second communication circuit 322 of the electronic device 320 is connected to the third communication circuit 332 of the external electronic device 330, the electronic device 320 may transmit the at least one image and curvature information to the external electronic device 330. According to various embodiments, the electronic device 320 may transmit not only the at least one image and curvature information but also the paint spray video for the target structure 11 obtained through the at least one camera of the painting device 310 to the external electronic device 330.

According to various embodiments, the electronic device 320 may obtain 811 the painting quality information by performing the operation described with reference to FIGS. 4 and 6 811. For example, the electronic device 320 may generate the painting quality information by applying the watershed algorithm based on the first color information of the at least one image and the second color information indicating the reference color of the paint.

According to various embodiments, the painting device 310 may transmit the coordinate information generated based on the relative coordinates 813 obtained through operation 803 to the electronic device 320. For example, the painting device 310 may transmit coordinate information, which is accumulated information of the relative coordinates, to the electronic device 320. Alternatively, the painting device 310 may obtain the relative coordinates and transmit coordinate information to the electronic device 320 according to a predetermined criterion.

According to various embodiments, the electronic device 320 may obtain 815 the movement path information of the painting device 815. For example, the electronic device 320 may obtain the movement path information by performing the operation described with reference to FIG. 7 based on the coordinate information.

According to various embodiments, the electronic device 320 may display the painting information for the target structure 817. For example, the electronic device 320 may display painting information including at least one of curvature information indicating a surface of the target structure 11, painting quality information indicating a painting state, movement path information of the painting device with respect to the target structure, painting quality information for each position of the painting device, curvature information for each position of the painting device, or a real-time video on which paint is sprayed through the second display 321 (e.g., the display 140 of FIG. 2). According to various embodiments, operation 817 may be omitted.

According to various embodiments, the electronic device 320 may transmit painting quality information and movement path information to the external electronic device 330 819. According to various embodiments, the electronic device 320 may transmit various information to the external electronic device 330 without being limited to the above-listed information. For example, the electronic device 320 may transmit painting quality information for each position and curvature information for each position obtained by performing the operation described with reference to FIG. 7 to the external electronic device 330.

According to various embodiments, the external electronic device 330 may output painting information for the target structure 821. For example, the external electronic device 330 may display painting information including at least one of curvature information indicating a surface of the target structure 11, painting quality information indicating a painting state, movement path information of the painting device with respect to the target structure, painting quality information for each position of the painting device, curvature information for each position of the painting device, or a real-time video on which paint is sprayed through the third display 331. According to various embodiments, operation 821 may be omitted.

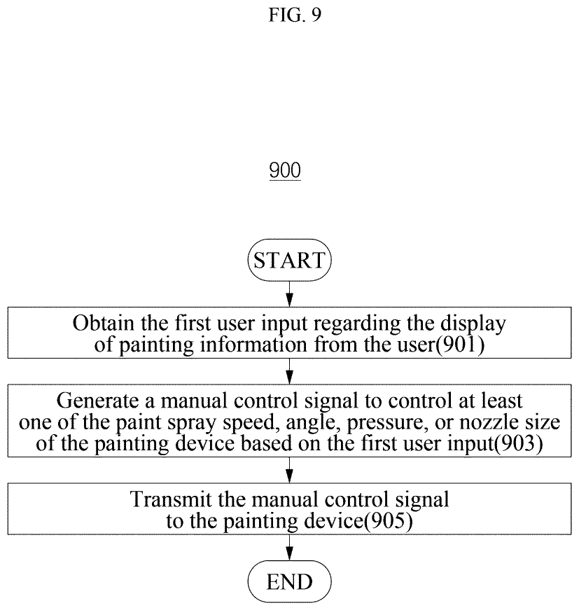

FIG. 9 is a flowchart 900 illustrating an operation in which the electronic device according to an embodiment transmits a manual control signal to the painting device according to a user input.

According to various embodiments, the operations illustrated in FIG. 9 may be performed in various orders without being limited to the illustrated order. In addition, according to various embodiments, more operations may be performed or fewer operations may be performed than the operations illustrated in FIG. 9.

Each of the operations described below may be performed in combination with each other. In addition, the operation by the electronic device 100 (e.g., the electronic device 15 of FIG. 1 and the electronic device 320 of FIG. 3) among the operations described below may mean the operation by the processor 110 of the electronic device 100 (e.g., the second processor 323 of FIG. 3).

Referring to FIG. 9, in operation 901, the electronic device 100 may obtain a first user input for painting information display from a user. For example, the electronic device 100 may obtain a touch input of the user through the display 140 (e.g., the first display 321 of FIG. 3). According to various embodiments, the first user input may be obtained based on the curvature information, painting quality information, and movement path information described with reference to FIGS. 4 to 7 as an input for painting information display. According to various embodiments, the first user input may include an input for controlling at least one of the spraying speed, angle, pressure, or nozzle size of the spraying device included in the painting device 310 (e.g., the painting device 13 of FIG. 1).

For example, based on the curvature information, if it is confirmed that the surface of the target structure 11 described with reference to FIG. 1 is a severe curvature, the first user input may include an input to reduce the spray speed of the spraying device, adjust the size of the spray angle, reduce the spray pressure, or reduce the size of the nozzle. For example, if it is confirmed that the surface of the target structure 11 described with reference to FIG. 1 is planar based on the curvature information, the first user input may include an input for increasing the spray speed of the spraying device, adjusting the size of the spray angle, increasing the spray pressure, or increasing the size of the nozzle. For example, based on the application quality information, if the application state of the paint to the surface of the target structure 11 described with reference to FIG. 1 is low quality, it may include an input for spraying the paint again.

According to various embodiments, in operation 903, the electronic device 100 may generate a manual removal signal for controlling at least one of a spraying speed, an angle, a pressure, or a nozzle size of the spraying device included in the painting device 310 based on the first user input.

According to various embodiments, in operation 905, the electronic device 100 may transmit the manual control signal to the painting device 310. For example, the electronic device 100 may transmit the painting device 310 to operate based on a manual control signal. According to various embodiments, the painting device 310 may control the components included in the painting device 310 based on the manual control signal obtained from the electronic device 100.

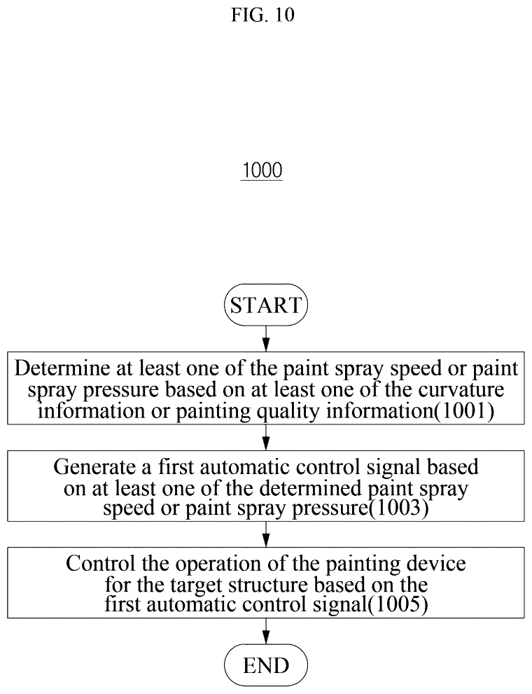

FIG. 10 is a flowchart 1000 illustrating an operation in which an electronic device automatically controls a painting device according to an embodiment.

According to various embodiments, the operations illustrated in FIG. 10 are not limited to the order illustrated, but may be performed in various orders. In addition, according to various embodiments, more operations may be performed or fewer operations may be performed than the operations illustrated in FIG. 10.

Referring to FIG. 10, the electronic device 100 may determine at least one of a paint spraying speed or a paint spraying pressure based on at least one of curvature information or paint quality information described with reference to FIGS. 4 to 6 in operation 1001.

For example, based on the curvature information, if it is confirmed that the surface of the target structure 11 described with reference to FIG. 1 is a severe curvature, the electronic device 100 may reduce the injection speed of the injection device or reduce the injection pressure. In addition, the electronic device 100 may adjust the size of the spray angle to produce the same effect indirectly, or may make a decision to reduce the size of the nozzle. For example, based on the curvature information, if it is confirmed that the surface of the target structure 11 described with reference to FIG. 1 is planar, the electronic device 100 may increase the injection speed of the injection device or increase the injection pressure. In addition, the electronic device 100 may adjust the size of the spray angle to produce the same effect indirectly or make a decision to increase the size of the nozzle. For example, based on the application quality information, if the application state of the paint on the surface of the target structure 11 described with reference to FIG. 1 is low quality, the electronic device 100 may make a decision to allow the paint to be sprayed again.

According to various embodiments, in operation 1003, the electronic device 100 may generate a first automatic control signal based on at least one of the determined paint spraying speed or paint spraying pressure. For example, the electronic device 100 may generate a first automatic control signal for controlling the spraying device of the paint device 310 based on at least one of the curvature information or the paint quality information.

According to various embodiments, in operation 1005, the electronic device 100 may control the operation of the paint device 310 on the target structure 11 based on the first automatic control signal. For example, the electronic device 100 may control the paint device 310 to operate based on the first automatic control signal. For example, the electronic device 100 may automatically control the operation related to the spraying of the paint device 310 based on the first automatic control signal.

According to various embodiments, the operation of the paint device 310 may be controlled by controlling the facilities included in the trailer 14 described with reference to FIG. 1.

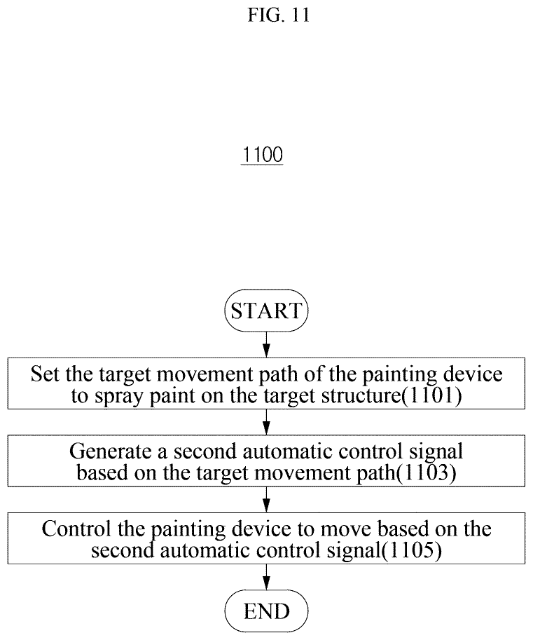

FIG. 11 is a flowchart 1100 illustrating an operation in which an electronic device according to an embodiment controls the movement of the paint device according to a target movement path.

According to various embodiments, the operations illustrated in FIG. 11 are not limited to the illustrated order, but may be performed in various orders. In addition, according to various embodiments, more operations may be performed or fewer operations may be performed than the operations illustrated in FIG. 11.

Referring to FIG. 11, in operation 1101, the electronic device 100 may set a target movement path of the paint device 310 (e.g., the paint device 13 of FIG. 1) described with reference to FIG. 3 for spraying the paint on the target structure 11 described with reference to FIG. 1. For example, the electronic device 100 may set a target movement path of the paint device 310 to allow the paint to be optimally applied to the surface of the target structure 11. According to various embodiments, the target movement path may refer to the movement path of the spraying device of the paint device 310.

According to various embodiments, in operation 1103, the electronic device 100 may generate a second automatic control signal based on the target movement path. For example, the electronic device 100 may generate a second automatic control signal for allowing the paint device 310 to move according to the target movement path. According to various embodiments, the second automatic control signal may include coordinate information for the paint device 310 to move.

According to various embodiments, in operation 1105, the electronic device 100 may control the paint device 310 to move based on the second automatic control signal. For example, the electronic device 100 may control the paint device 310 to move based on the second automatic control signal on the surface of the target structure 11.

According to various embodiments, the paint device 310 may spray the paint according to the target movement path as the spraying device is moved based on the second automatic control signal.

According to various embodiments, the operation of the painting device 310 may be controlled by controlling the equipment included in the trailer 14 and high place operation car 12 described with reference to FIG. 1.

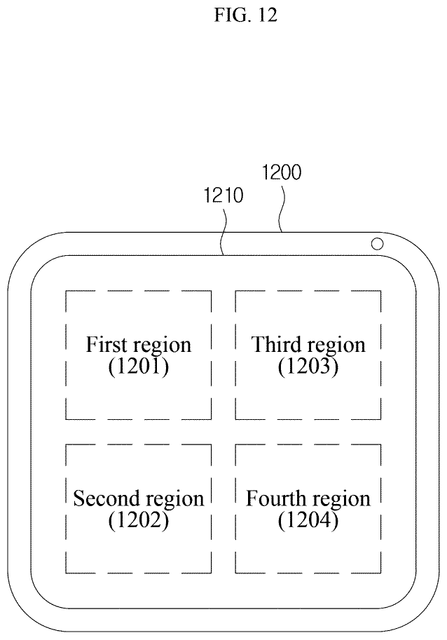

FIG. 12 is a diagram for illustrating a user interface of painting information shown on a display, according to an embodiment.

Referring to FIG. 12, a display device 1200 (e.g., the electronic device 320 of FIG. 3 or the external electronic device 330 of FIG. 3) and a third display 1210 (e.g., the first display 321 of FIG. 3 or the second display 331 of FIG. 3) included in the display device 1200 are illustrated.

According to various embodiments, the third display 1210 may include a first region 1201, a second region 1202, a third region 1203, or a fourth region 1204. According to various embodiments, the third display 1210 may include regions for displaying various visual objects without being limited to the regions illustrated in FIG. 12. Alternatively, the third display 1210 may omit some regions by overlappingly displaying at least one of the various visual objects.

According to various embodiments, the third display 1210 may display various visual objects representing painting work for the target structure 11 described with reference to FIG. 1. For example, the third display 1210 may display at least one of the video in which the painting device 310 described with reference to FIG. 3 distributes the paint, painting quality guide information, the spray angle, the spray pressure, the flow rate of the painting described with reference to FIG. 1, the distance from the painted surface of the target structure 11, the state of the high place operation car 12 described with reference to FIG. 1, the curvature information described with reference to FIGS. 4 to 7, the state of the display device 1200, and the movement path information of the painting device 310.

According to various embodiments, the information may be distributed and displayed in the first region 1201, the second region 1202, the third region 1203, or the fourth region 1204.

For example, the first region 1201 may display the movement path information of the painting device 310 for the target structure 11. In this case, separately from the movement path information, the painting quality information for each position of the painting device 310 and the curvature information for each position of the painting device 310 may be displayed. Alternatively, in response to a user input (e.g., touch input) on the movement path information, the painting quality information for each position of the painting device 310 and the curvature information for each position of the painting device 310 may be displayed.

For example, the second region 1202 may display a real-time video in which the painting is being sprayed on the target structure 11. For example, the third region 1203 may display curvature information representing the surface of the target structure 11. For example, the fourth region 1204 may display painting quality information representing the painting state for the target structure 11.

According to various embodiments, the display device 1200 may correct the video in which the painting device 310 distributes the paint, the painting quality guide information, the spray angle of the spraying device, the spray pressure, the flow rate of the paint, the distance between the target structure 11 and the painted surface, the state of high place operation car 12, the curvature information, the state of the display device 1200, or the movement path information of the painting device 310 in a direction for increasing the visibility of the user and display the same through the third display 1210.

As described above, an electronic device (e.g., the electronic device 15 of FIG. 1, the electronic device 100 of FIG. 2, and the electronic device 320 of FIG. 3) according to various embodiments may include a communication circuit (e.g., the communication circuit 130 of FIG. 2, the second communication circuit 322 of FIG. 3), a display (e.g., the display 140 of FIG. 2, the first display 321 of FIG. 3), and at least one processor (e.g., the processor 110 of FIG. 2, and the second processor 323 of FIG. 3), wherein the at least one processor may obtain at least one image related to spraying a paint onto a target structure through at least one camera connected to the electronic device, wherein the at least one camera is included in a painting device that sprays the paint onto the target structure, obtain depth information corresponding to the at least one image through the at least one camera and at least one sensor included in the at least one camera, obtain a depth image based on the depth information and the at least one image, obtain curvature information identifying a surface curvature of the target structure based on the depth image, obtain paint quality information of the paint about the target structure according to a specified algorithm based on color information of the at least one image and reference color information related to the paint, and display painting information including the curvature information and the painting quality information through the display.

According to various embodiments, the at least one processor may identify a hole of a depth map image based on the depth information, obtain a corrected depth map image by performing correction to fill the hole of the depth map image when there is a hole in the depth map image, and obtain the depth image based on the corrected depth map image and the at least one image.

According to various embodiments, the at least one processor may obtain boundary information based on first color information of the at least one image, obtain intensity information about the first color information and the second color information by applying a watershed algorithm to the reference color of the paint and the boundary information, and obtain the painting quality information based on the intensity information.

According to various embodiments, the at least one sensor may include a position sensor, and the at least one processor may obtain coordinate information from the position sensor operated as the at least one camera is activated through the communication circuit, and obtain movement path information of the painting device based on the coordinate information.

According to various embodiments, the at least one processor may obtain an video related to spraying the paint onto the target structure through the at least one camera, and display at least one of the video, the curvature information, the painting quality information, or the movement path information through the display.

According to various embodiments, the at least one processor may obtain painting quality information for each position and curvature information for each position corresponding to each of the positions where the painting device moves based on at least the movement path information, and display painting information for each position combining the movement path information with at least one of the painting quality information for each position or the curvature information for each position through the display.

According to various embodiments, the at least one processor may transmit at least one of the painting quality information, the curvature information, the movement path information, or the position-specific painting information through the communication circuit so that an external device can output at least one of the painting quality information, the curvature information, the movement path information, or the painting information for each position.

According to various embodiments, the at least one processor may obtain a first user input for the painting information from a user of the electronic device, generate a manual control signal for controlling at least one of a paint spray speed, an angle, a pressure, or a size of a nozzle of the painting device based on the first user input, and transmit the manual control signal to the painting device through the communication circuit.

According to various embodiments, the at least one processor may determine at least one of a paint spray speed, an angle, a pressure, or a size of a nozzle of the painting device based on at least one of the curvature information or the painting quality information, generate a first automatic control signal for controlling the painting device based on the determination result, and control an operation of the painting device with respect to the target structure based on the first automatic control signal.

According to various embodiments, the at least one processor may set a target movement path of the painting device for spraying the paint to the target structure, generate a second automatic control signal based on the target movement path, and control the painting device to move with respect to a surface of the target structure based on the second automatic control signal.

As described above, an operation method of an electronic device connected to a painting device that sprays paint to a target structure may include: obtain at least one image related to spraying paint to the target structure through at least one camera included in the painting device (e.g., operation 401 in FIG. 4), obtain depth information corresponding to the at least one image through the at least one camera and at least one sensor included in the at least one camera (e.g., operation 403 in FIG. 4), obtain a depth image based on the depth information and the at least one image (e.g., operation 405 in FIG. 4), obtain curvature information identifying a surface curvature of the target structure based on the depth image (e.g., operation 407 in FIG. 4), obtain painting quality information of the paint with respect to the target structure according to a specified algorithm based on color information of the at least one image and reference color information related to the paint (e.g., operation 409 in FIG. 4), and display painting information including the curvature information and the painting quality information through a display included in the electronic device (e.g., operation 411 in FIG. 4).

According to various embodiments, the operating method of the electronic device may further include obtaining coordinate information through the position sensor included in the at least one sensor, through the position sensor operating as the at least one camera is activated, and obtaining movement path information of the painting device based on the coordinate information.

According to various embodiments, the operating method of the electronic device may include obtaining a video related to spraying the painting material to the target structure through the at least one camera, and displaying at least one of the video, the curvature information, the painting quality information, or the movement path information through the display.

According to various embodiments, the operating method of the electronic device may further include obtaining painting quality information for each position and curvature information for each position corresponding to each of the positions moved by the painting device, obtaining painting information for each position combining the movement path information with at least one of the painting quality information for each position or the curvature information for each position, and displaying the painting information for each position through the display, based on at least the movement path information.

According to various embodiments, the operating method of the electronic device may further include transmitting, by an external device connected with the electronic device, at least one of the painting quality information, the curvature information, the movement path information, or the painting information for each position to be displayed through a display included in the external device.

As described above, an electronic device (e.g., the electronic device 15 of FIG. 1, the electronic device 100 of FIG. 2, and the electronic device 320 of FIG. 3) may include a communication circuit (e.g., the communication circuit 130 of FIG. 2, the second communication circuit 322 of FIG. 3), a memory (e.g., the memory 120 of FIG. 2), and at least one processor (e.g., the processor 110 of FIG. 2, and the second processor 323 of FIG. 3), and the at least one processor may obtain at least one image related to spraying painting material to the target structure through at least one camera connected with the electronic device, the at least one camera included in the painting device spraying the painting material to the target structure, obtain depth information corresponding to the at least one image through the at least one camera and at least one sensor included in the at least one camera, obtain a depth image based on the depth information and the at least one image, obtain curvature information identifying surface curvature of the target structure based on the depth image, obtain painting quality information of the painting material for the target structure according to a specified algorithm based on color information of the at least one image and reference color information related to the painting material, and transmit, through the communication circuit, by an external electronic device connected with the electronic device, to output painting information including the curvature information and the painting quality information.

According to various embodiments, the at least one sensor may include a position sensor, and the at least one processor may obtain coordinate information from the position sensor operating as the at least one camera is activated through the communication circuit, obtain movement path information of the painting device based on the coordinate information, and transmit the movement path information to the external electronic device through the communication circuit.

The at least one processor may obtain a video related to spraying the paint to the target structure through the at least one camera and transmit the video to the external electronic device through the communication circuit.

According to various embodiments, the at least one processor may obtain painting quality information for each position and curvature information for each position corresponding to each of the positions where the painting device moves, based on at least the movement path information, and transmit painting information for each position combining the movement path information with at least one of the painting quality information for each position or the curvature information for each position to the external electronic device through the communication circuit.

According to various embodiments, the at least one processor may generate an automatic control signal for controlling at least one of a paint injection speed, an angle, a pressure, or a size of a nozzle of the painting device based on the curvature information, the painting quality information, or the movement path information, and control the operation of the painting device with respect to the target structure based on the automatic control signal.

In the present disclosure, each of the phrases such as “a or b,” “a and b at least one of a and b,” “a and b at least one of a and b,” “a, b, or c,” “a, b, and c at least one of a and b,” and “a, b, or c at least one of a and b,” may include any one of the items listed together in the corresponding phrase among the phrase, or any combination of them.

Terms such as “first”, “second”, or “first” may be used simply to distinguish a corresponding component from another corresponding component, and the corresponding components are not limited in other aspects (e.g., importance or order).

The term “module” used in various embodiments of the present disclosure may include a unit implemented in hardware, software, or firmware. For example, it may be used interchangeably with terms such as logic, logical blocks, components, or circuits. A module may be an integrated component or a minimum unit or part of the component that performs one or more functions.

Various embodiments of the present disclosure may be implemented as software (e.g., a program) including one or more commands stored in a memory 120 (e.g., an internal memory or an external memory) that can be read by a device (e.g., the electronic apparatus 100). The memory 120 may be represented as a storage medium.

According to an embodiment, the method according to various embodiments disclosed in this document may be included and provided in a computer program product. Computer program products can be traded between sellers and buyers as goods. The computer program product may be distributed in the form of a readable storage medium (e.g., compact disc read only memory (CD-ROM)), or may be distributed (e.g., downloaded or uploaded) online through an application store or between two user devices.

According to various embodiments, each component (e.g., module or program) of the above-described components may include a single entity or a plurality of entities, and some of the plurality of entities may be separately arranged in other components. According to various embodiments, one or more components or operations among the above-described corresponding components may be omitted, or one or more other components or operations may be added. Additionally or alternatively, a plurality of components (e.g., modules or programs) may be integrated into one component. In this case, the integrated component may perform one or more functions of each component of the plurality of components in the same or similar manner as performed by the corresponding component among the plurality of components before the integration.

According to various embodiments, operations performed by a module, a program, or another component may be executed sequentially, in parallel, repeatedly, or heuristically, one or more of the operations may be executed in a different order, omitted, or one or more other operations may be added.

What is claimed is:

1. An electronic device comprising: a communication circuit; a display; and at least one processor, wherein the at least one processor obtains at least one image related to spraying paint onto a target structure through at least one camera connected to the electronic device, wherein the at least one camera is included in a paint device that sprays the paint onto the target structure; and obtains depth information corresponding to the at least one image through the at least one camera and at least one sensor included in the at least one camera, obtains at least one depth image based on the depth information and the at least one image, obtains curvature information identifying surface curvature of the target structure based on the at least one depth image, obtains paint quality information of the paint about the target structure according to a specified algorithm based on color information of the at least one image and reference color information related to the paint, and displays paint information including the curvature information and the paint quality information through the display.

2. The electronic device of claim 1,
wherein the at least one processor identifies a hole of a depth map image based on the depth information, obtains a corrected depth map image by performing correction to fill the hole of the depth map image when there is a hole in the depth map image, and obtains the depth image based on the corrected depth map image and the at least one image.

3. The electronic device of claim 1, wherein the at least one processor obtains boundary information based on first color information of the at least one image, obtains intensity information about the first color information and the second color information by applying a watershed algorithm to the boundary information and second color information indicating the reference color of the paint, and obtains the paint quality information based on the intensity information.

4. The electronic device of claim 1, wherein the at least one sensor includes a position sensor, and the at least one processor obtains coordinate information from the position sensor that operates as the at least one camera is activated through the communication circuit, and obtains movement path information of the paint device based on the coordinate information.

5. The electronic device of claim 4, wherein the at least one processor obtains a video related to spraying the paint onto the target structure through the at least one camera, and displays at least one of the video, the curvature information, the paint quality information, or the movement path information through the display.

6. The electronic device of claim 4, wherein the at least one processor obtains paint quality information for each position and curvature information for each position corresponding to each of the positions the paint device moved based on at least the movement path information, and displays paint information for each position by combining at least one of the paint quality information for each position or the curvature information for each position with the movement path information through the display.

7. The electronic device of claim 6, wherein the at least one processor delivers at least one of the paint quality information, the curvature information, the movement path information, or the paint information for each position through the communication circuit so that an external device can output at least one of the paint quality information.

8. The electronic device of claim 1, wherein the at least one processor obtains a first user input for the painting information from a user of the electronic device, generates a manual control signal for controlling at least one of a paint spray speed, an angle, a pressure, or a size of a nozzle of the painting device based on the first user input, and transmits the manual control signal to the painting device through the communication circuit.

9. The electronic device of claim 1, wherein the at least one processor determines at least one of a paint injection speed, an angle, a pressure, or a size of a nozzle of the painting device based on at least one of the curvature information or the painting quality information, generates a first automatic control signal for controlling the painting device based on the result of the determination, and controls the operation of the painting device with respect to the target structure based on the first automatic control signal.

10. The electronic device of claim 1, wherein the at least one processor is configured to set a target movement path of the painting device for spraying the paint to the target structure, generate a second automatic control signal based on the target movement path, and control the painting device to move with respect to the surface of the target structure based on the second automatic control signal.

11. An operating method of an electronic device connected to a painting device that sprays paints to a target structure, the method comprising: obtaining at least one image related to spraying paints to the target structure through at least one camera included in the painting device; obtaining depth information corresponding to the at least one image through at least one sensor included in the at least one camera and the at least one camera; obtaining at least one depth image based on the depth information and the at least one image; obtaining curvature information identifying surface curvature of the target structure based on the at least one depth image; obtaining paint quality information of the paints for the target structure according to a designated algorithm based on color information of the at least one image and reference color information related to the paints; and displaying painting information including the curvature information and the painting quality information through a display included in the electronic device.

12. The method of claim 11, further comprising: obtaining coordinate information through the position sensor included in the at least one sensor, wherein the at least one camera is activated; and obtaining movement path information of the painting device based on the coordinate information.

13. The method of claim 12, further comprising: obtaining a video related to spraying the paint to the target structure through the at least one camera; and displaying at least one of the video, the curvature information, the paint quality information, or the movement path information through the display.

14. The method of claim 12, further comprising: obtaining painting quality information for each position and curvature information for each position corresponding to each of the positions moved by the painting device based on at least the movement path information; obtaining painting information for each position by combining at least one of the painting quality information for each position or the curvature information for each position with the movement path information; and displaying the painting information for each position through the display.

15. The method of claim 14, further comprising transmitting at least one of the painting quality information, the curvature information, the movement path information, or the position-specific painting information to an external device connected to the electronic device so that the at least one of the painting quality information, the curvature information, the movement path information, or the painting information for each position can be displayed through a display included in the external device.
